(19) United States
(12) Patent Application Publication
(10) Pub. No.: US 2024/0236205 A1
(43) Pub. Date: Jul. 11, 2024

(54) METHOD OF MATCHING ANALYTICS AND COMMUNICATION ESTABLISHMENT

(71) Applicant: FRIENDLYBUZZ COMPANY, PBC, Surfside, FL (US)

(72) Inventors: Levi Marelus, Antwerp (BE); Michael Marelus, Antwerp (BE)

(21) Appl. No.: 18/563,854

(22) PCT Filed: May 25, 2022
(86) PCT No.: PCT/US2022/030949

§ 371 Date: Nov. 22, 2023

Related U.S. Application Data
(60) Provisional application No. 63/193,027, filed on May 25, 2021.

(51) Int. Cl. H04L 67/60; G06F 16/23

(52) U.S. Cl. CPC H04L 67/60; G06F 16/2379

(57) ABSTRACT

Systems and methods here may be used to network, including using a computing system to match data to previously stored data using data regarding questionnaire data, geography, voice analysis, and preferences and/or to match.

### CROSS REFERENCE TO RELATED APPLICATION

This application relates to and claims priority from U.S. Provisional Application No. 63/193,027 filed on May 25, 2021, the entirety of which is hereby incorporated by reference.

### FIELD

This application relates to the field of distributed computing networks and communication establishment among distributed nodes.

### BACKGROUND

Many distributed computing networks and application program interfaces allow for matching nodes based on metadata and pre-described identifiers but use outdated and cumbersome techniques to do so. There exists a need for better matching and related technologies for network employment.

### SUMMARY

Systems and methods here may be used to network, including using a computing system to match data to previously stored data using data regarding questionnaire data, geography, voice analysis, and preferences and/or to connect nodes of the system. In some example systems and methods a computer with a processor and memory, may be used for receiving data regarding a first node; matching the first node data with a second node data based on the received first node data by comparison to previously stored other nodes in a database, scheduling a communication between the first node and a matched second node from the database using the data of the first node and stored data of the second node, initiating the scheduled communication between the first node and the second node, and receiving data regarding the communication between the first node and the second node.

In some example systems and methods a computer with a processor and memory, may be used for receiving data regarding a first node including geographical data and communications data; matching the first node data with a second node data based on the received first node data by comparison to previously stored other nodes in a database, scheduling a communication between the first node and a matched second node from the database using the geographic data of the first node and stored geographic data of the second node, initiating the scheduled communication between the first node and the second node using the first node communications data and stored communications data of the second node, receiving voice data regarding the communication between the first node and the second use, wherein the voice data includes tone data, comparing the received voice data of the first node and the second node to a predefined threshold of tone between 120 Hz and 180 Hz for a male and between 180 and 255 Hz for a female, if the received voice data of the first node and the second node exceeds the predefined threshold of tone, storing an indicator of success. In some examples, a preselected range is above 150 Hz. In some examples, a preselected range is between 150 Hz and 200 Hz.

In some examples, alone or in combination, the voice data is a speech recording of a telephone conference. In some examples, alone or in combination, the comparing step uses a natural language processing engine to determine the match. In some such examples, alone or in combination, the matching utilizes a check of whether the first node has opted for a wildcard match, and if so, overriding algorithms used for matching and utilizing a random number generator to match the second node. In some examples, alone or in combination, the matching of the first node and the second node includes matching both a stored Boolean value and a scaled value. And in some examples, alone or in combination, the matching includes a specific purpose variable and weighted factors for matching based on the specific purpose variable. In some such examples, alone or in combination, the matching includes an index file match or previously stored data flags for each of the node. In some examples, alone or in combination, the scheduling includes utilizing geographic data of the first node and geographic data of the second node along with previously stored calendar data of the first node and calendar data of the second node. In some examples, further comprising, wherein the matching is made by a daemon module configured to monitor for matching criteria in the index file to match the first node data. Some examples further comprising, alone or in combination, the matching includes only time stamped data that has not been expunged from the database for aging over a predefined time limit.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an example flowchart depicting data gathering and matching according to examples described herein;

FIG. 2 is example flowchart depicting an approved node identification process according to examples described herein;

FIG. 3 is an example flowchart depicting an introduction and connection process according to examples described herein;

FIG. 4 is an example flowchart depicting the matching process according to examples described herein;

FIG. 5 is an example flowchart depicting a system scheduling phone call according to examples described herein;

FIG. 6 is an example flowchart depicting the open enterprise, private consumer, and intranet networks according to examples described herein; and

FIG. 7 is an example flowchart depicting a calling system according to examples described herein;

FIG. 8 is an example flowchart of an embodiment of a computer implemented method of determining a matching score when bringing at least a first and a second individual into contact with each other for a predefined purpose or endeavor, according to examples described herein;

FIG. 9 is an example high-level block-diagram of an embodiment of a system according to the present invention, configured for finding two matching individuals for a particular purpose or endeavor, and bringing these individuals into communication with each other according to examples described herein; and

FIG. 10A to FIG. 10C show examples of data records, as may be used in various embodiments according to the present invention.

### DETAILED DESCRIPTION

### Overview

Systems and methods described herein may be used to, amongst others, help users make connections and introduce them to each other in general or in specific ways; the systems and methods described herein may, in whole or in part, be used as a professional networking tool, as a matchmaking tool, as a dating platform, as a friend-making platform, as a product or service marketplace, as a hiring platform, or in any other way.

Systems and methods described herein may be used to, amongst others, make connections of disparate node groups using preselected data and data gathered for specific purpose. The system can also, for example, utilize data acquired through registration, data acquired from onboarding and/or other system interactions, which may be combined with other sources of data, the algorithmic matching of node profiles with other node profiles (in single or in groups), which may be optimized using various criteria described herein, a networked communication system (or systems) that allows node interaction, and a communications system (or systems) that connects these nodes to each other to communicate.

Communication may be, but is not limited to phone calls, email, video, text, audio, or other forms of communication, either manual (e.g. a node (or nodes) triggers the communication) or the communication is triggered automatically (e.g. the system calls the nodes' telephone at a predetermined time—all the node needs to do is pick the phone up when it rings). Communication may be over the telephone network or over a computer network, e.g. over a LAN or WAN connected to the Internet or over a mobile data communication network, including through virtual and/or augmented reality (including the so-called metaverse), and/or through in-person and/or written communications (e.g. letters), all by either using a communication system inherent to the system itself or through an external communication system.

In some examples, systems and methods described herein allow communication to be anonymized, e.g. where the communication is by telephone, the system so routes the calls so that the telephone number, or other identifying information, of each of the nodes, as an example, is not shared between the nodes. For example, all the nodes might see is the phone number chosen by or otherwise belonging to or managed or controlled by the system. To do so, the system may be configured to send an anonymization request to an intermediate communication server connecting the nodes to each other, for example using a service code in case of telephony, or indeed the system may do the calling itself and using a centralized number controlled by the system, or may be configured to use pseudonymization or hashing or encrypting of the identifying information. Alternatively, the system may be configured to strip or obfuscate any relevant identifying information at an intermediate communication server connecting the nodes to each other. An additional manner of doing so is described further below.

### Data Gathering

Methods and systems described herein may be used to gather data on its nodes through the node registration, the node onboarding, and/or third-party sources or other sources. The nodes themselves can register and onboard, or a third person can register and onboard a node or multiple nodes on their behalf. Registration and onboarding may happen online, through a web-portal, API, or other mobile or desktop application, by telephone, or any other manner (including for example through a manual paper submission). An example of a registration and onboarding procedure includes a node (or their authorized) accessing the web-portal, API, or other mobile or desktop application and entering relevant data, e.g. into a web form, or even into a free-text input field. Alternatively, or additionally, the node may input the relevant data by uploading a speech recording of those data, which speech recording is subsequently analyzed and interpreted with a natural language processing engine to determine the relevant data.

Data regarding each a node may be collected through the registration and onboarding process, and/or at other points in the node's use of or interaction with the system, in addition to data from other sources. These other sources include and are not limited to data scraped or otherwise obtained from public sources, data from private sources, data obtained through feedback mechanisms, recommendation algorithms, other algorithms, artificial intelligence, machine learning, and/or data obtained from a node past online and recorded behaviors such as but not limited to recorded online purchases, advertisements interacted with, web browsing page histories, and other online activities recorded using cookies and web history technologies: any relevant or potentially relevant data may be collected (when it is legal to do so). Data may be provided by, for example, but not limited to, a keyboard (e.g. in response to messages shown on a screen), a mouse or other pointer device (e.g. using pull-down menus shown on a screen), a data carrier such as for example a CD-ROM, data-communication over an internet-connection, by manual paper (e.g. a mail-in form), over the phone, any other data source mentioned above, or combinations hereof In addition, the system may gather data from third parties and/or public and/or private sources of information, and/or other sources. To improve future effectiveness, it is preferred to collect more data rather than fewer data.

The system may also include functionality that enables the node to identify when they are available for upcoming connections with their match (or group of matches). The system may, additionally or alternatively, obtain that information by gaining access to a node's calendar or through some other way. The system may then use the data on availability of two or more uses to determine a suitable and/or ideal time for those nodes to meet (whether by phone, in person, video, etc. as further described herein), and to communicate such meeting time with the nodes or otherwise set up such meeting. The node may for example be asked if they use an electronic agenda or calendar, e.g. Microsoft Outlook®, or Google Calendar, or other software or system, and the node may be asked, e.g. when registering, whether they allow the computer server to access their calendar. A scheduling assistant may be implemented into the electronic agenda or calendar that is configured to poll an electronic agenda or calendar of another node in order to determine shared free slots (possibly subject to other conditions defined by the other node regarding generally allowable time slots). The electronic agendas or calendars may also then be configured to communicate with our system and/or with each other, e.g. via the Internet, to determine those shared free slots, either directly or indirectly.

In addition, or in the alternative, the system may collect location and/or other geographic data from a node (e.g. by registering IP address location, device time zone settings, data from node submission, etc.) and adding that to the database, and use that data (either alone or in combination with other data) to determine a suitable match, location, and/or the like. For example, the system can then match person A and person B, knowing that both people are in a certain city, and schedule a match between those persons, to, for example, meet at a coffee shop that is convenient for both nodes. Similarly, when combining that data with other data (e.g. the interests of a node (which, for example, the node submitted as part of its onboarding process, or which the system obtains from any other source, e.g. posted media) and which is now stored in the database), the system can create a suitable match and recommend suitable in-person or virtual experiences (e.g. two nodes with an interest in modern art may be recommended to a local exhibition in walking distance from their respective location).

In addition, as part of the data gathering of the system, the system may, for example, and amongst other data, obtain access to a node's contact list or phone book, or otherwise obtain such information, or ask a node for such information, and use such information, for various purposes including to connect a node with their existing contacts or, for example, with nodes that are contacts of said node's contacts or otherwise suitable for connecting, or invite such persons to join the system.

In addition, as part of the data gathering of the system, the system may, for example, and amongst other data (as noted), obtain access to a node's calendar, or otherwise obtain such information, and use such information for various purposes including, for example, to enable the system to schedule a meeting between said node and another node or group of nodes. In addition, and as an example, the system may take this information and use it in suggesting suitable times during the opt-in process described herein.

Additionally or alternatively, in some examples, the system may obtain, and use, audio data, and/or image data such as images of faces or other data to analyze and/or to determine whether two or more nodes should be matched—or if they are matched, whether they are a suitable match. In order to do so, the system may of course for example comprise an audio or image capturing device, such as a microphone and/or a camera, configured to capture the audio data and/or the image data. The audio data and/or image data may optionally be stored and may be fed (either from the storage or directly, e.g. via a serial interface) into a module of the system that is configured for analyzing such data. Examples of using audio data include voice recordings. Examples of image data include analysis of facial images. In some examples, such analysis may include but is not limited to the nodes' synchrony (on the basis of principles in the field of interpersonal synchrony and relationships: e.g. as a simple example, using audio data to determine voice pitch to analyze how well nodes are connecting or will connect, with higher pitches indicating better connections than lower pitches on average throughout a conversation). Predefined threshold of audio pitch used to make this determination. Examples of the threshold may be: 150 Hz. Other examples are, detection of irritation or frustration in the voice, frequency of how often one individual interrupts another individual, loudness of the voices (e.g. whether above 76 dB), frequency of laughing, etc. For example, an AI algorithm may be trained using a deep learning technique based on previous recordings, to detect a level of irritation or frustration or domination or smoothness or contentedness or happiness of a conversion, and may convert those findings to a matching score or use in some other manner.

### Matching, Introductions and Connections

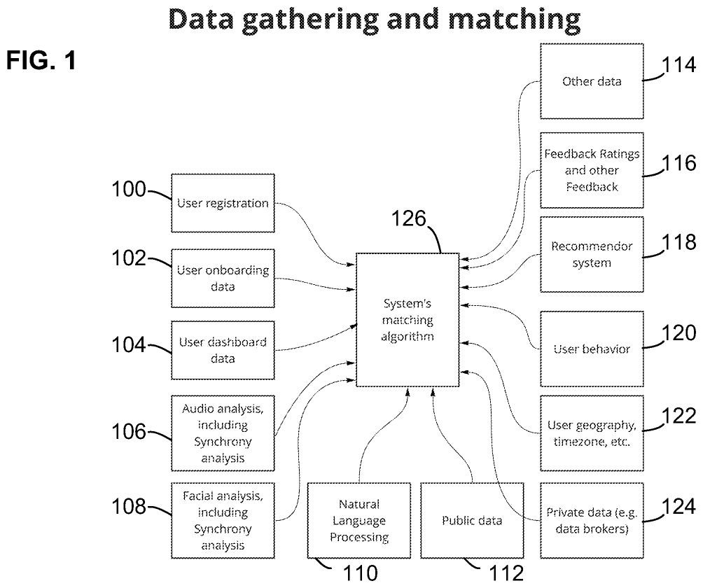

Using the data above, in whole or in part, and algorithmic designs and other features, the system may match a node with another node (or multiple nodes are matched with each other as groups). The algorithmic designs and other features may enable the system to create optimized matches based on any number of preselected criteria (see for example FIG. 1 As a basic example, the system may match a node who has been identified by the system or through any other mechanism to have certain pre-defined characteristics, with a node who is most suited to support that characteristic. The system can match and/or connect individual nodes as well as multiple nodes together.

FIG. 1 shows an example of data gathering and matching. In FIG. 1, the system matching algorithm 126 may be fed with any number of data, in any combination as described herein. Examples of data may include, but are not limited to data from node registration 100 and onboarding 102; data from node dashboard 104; audio data analysis of voice recordings 106; image data analysis such as facial recognition 108; natural language processing data 110; public data 112; private data from brokers 124; node geography data as reported by their device 122; past recorded node behavior 120; recommender systems 118; feedback ratings 116; and/or other data 114. As noted, the data may be collected for example by surveys, data provided by the node when registering for a particular course or endeavor, and the like.

As shown in FIG. 1, Data gathering and matching, User registration 100, User onboarding data 102, User Dashboard data 104, Audio analysis, including Synchrony analysis 106, Facial analysis, including Synchrony analysis 108, Natural Language Processing 110, Public data 112, Other data 114, Feedback Ratings and other Feedback 116, Recommender system 118, User behavior 120, User geography, time zone, etc. 122, Private data (e.g. data brokers) 124, System's matching algorithm 126.

The system and methods here may use some or all of the data gathered, and continue to gather during use, in creating matches between nodes by using algorithmic analysis and/or other methods.

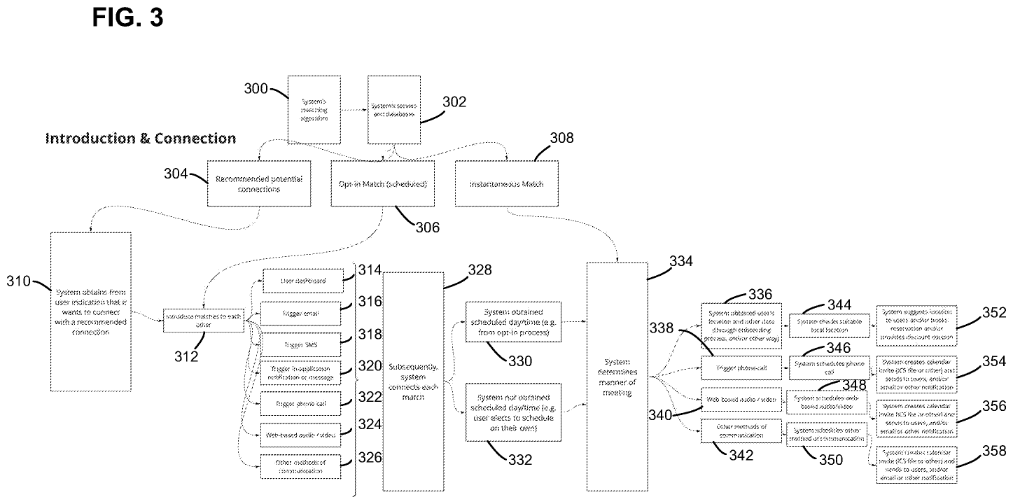

FIG. 3 shows an example flow chart of Introduction and Connections from systems and methods described herein. In the example, the System matching algorithm 300 is used by the System servers and databases 302 to populate the Recommended Potential Connection 304, Opt-In Match 306, and/or Instantaneous Match 308. In the example of the Recommended Potential Connection 304, the System may obtain from nodes, an indication that it wants to connect with a recommended connection 310 as displayed to the node. In such examples, the system may introduce matches to one another 312 as described herein using communication methods. In the Opt-In Match option, the same Introduction to Matches 312 occurs.

In such examples, the Introduction to Matches 312 prompts a node dashboard with the match information 314, triggers any of various communications, such as but not limited to any combination or permutation of, an email to be sent to the two nodes 316, triggers an SMS message to the two nodes 318, triggers an in-application communication message 320, triggers a phone call 322, triggers a web-based audio and/or visual communication 322, and/or other method of communication.

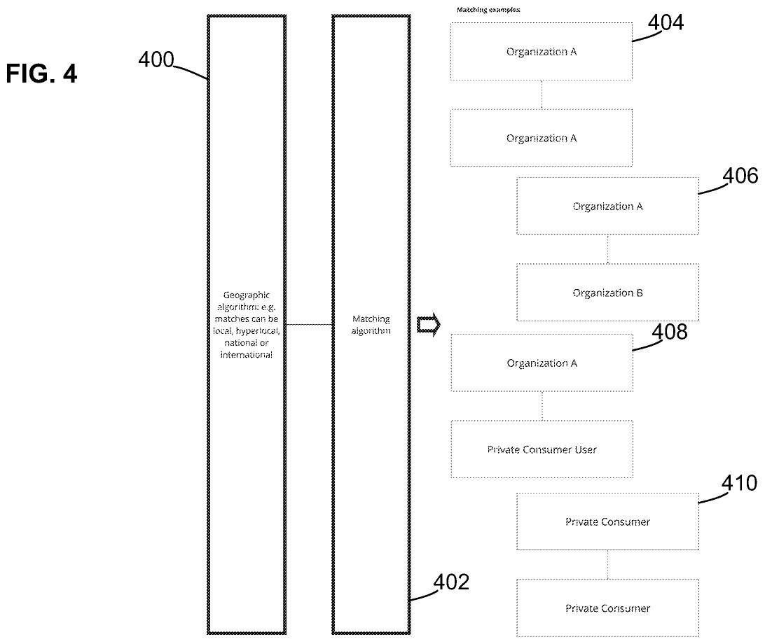

In these examples, the System subsequently connects each matched node 328. From or for these connections, the system may obtain scheduled preferences of day/time information from an opt-in process 330 and/or scheduled day/time information from a node election to schedule on her own 332. Scheduled communication preferences may be fed, or may have been fed, into the system to determine a manner of meeting 334. Once determined, the system may make the connection using any number of communications such as but not limited to obtaining a node's geographical location 336 and then checking for a location 344 within a pre-determined boundary threshold before suggesting a location to meet 352. See FIG. 4.

In the examples of an instantaneous match 308, the system skips to the determination of manner of meeting 334. In another example, the system may trigger a phone call 338, then schedule a phone call 346, then create a calendar invitation to send to the node for the scheduled call or video call 354.

In another example, the system may arrange a web-based audio or video call 340. The system may then schedule web-based audio/visual call 348. Finally, the system may create a calendar invitation to send to the node for the scheduled call or video call 356.

In another example, the system may arrange some other communication 342. The system may schedule web based or other communication 350. Finally, the system may create a calendar invitation to send to the node for the scheduled communication 358.

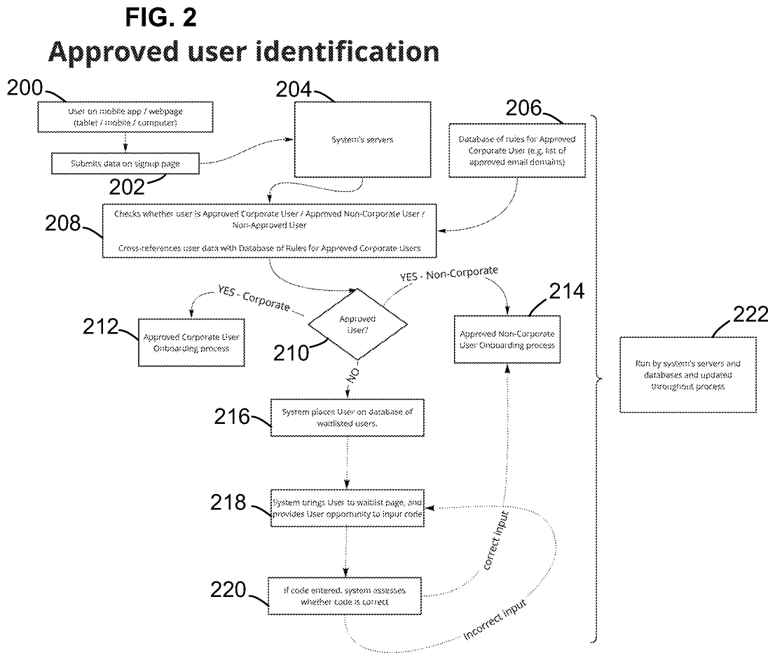

The system may also use AI and/or machine learning, such as, for example, natural language processing, to, for example, understand from a node's input what the node preferences are, and utilize that data and preference request when creating matches between nodes or groups of nodes. Other elements which may be taken into account by the system in creating matches, and/or for other purposes, includes and is not limited to recommender systems, node rating systems, and others. (See for example FIG. 2.) Regarding FIG. 3, System's matching algorithm 300, System's servers and databases 302, Recommended potential connections 304, Opt-in Match (scheduled) 306, Instantaneous Match 308, System obtains from user identification that it wants to connect with a recommended connection 310, Introduce matches to each other 312, User dashboard 314, Trigger email 316, Trigger SMS 318, Trigger in-application notification of message 320, Trigger phone-call 322, Web-based audio/video 324, Other methods of communication 326, Subsequently, system connects each match 328, System obtained scheduled day/time (e.g. from opt-in process) 330, System not obtained scheduled day/time (e.g. user elects to schedule on their own) 332, System determines manner of meeting 334, System obtained user's location and other data (through onboarding process, and/or other way) 336, Trigger phone-call 338, Web-based audio/video 340, Other methods of communication 342, System checks suitable local location 344, System schedules phone call 346, System schedules web-based audio/video 348, System schedules other method of communication 350, System suggests location to users and/or books reservation and/or provides discount coupon 352, System creates calendar Invite (ICS file or other) and sends to user, and/or email or other notification 354, System creates calendar invite (ICS file or other) and sends to users, and/or email or other notification 356, System creates calendar invite (ICS file or other) and sends to users, and/or email or other notification 358.

As elaborated further herein, the system and methods here may allow nodes to match within an organization (e.g. enterprise) and also to match across different organizations and/or with nodes not affiliated with or non-members of an organization. The system and methods here may allow this even where the different organizations have different security or other requirements or log-in processes or node management processes or requirements. For example, say Company A is a registered enterprise node of the system. The system may allow employees of Company A to be matched, introduced and/or connected to other Company A employees, e.g. employees in India (and timing not being an issue due to the manner the system considers and takes into account time zones). In addition, Company A employees may be matched with employees of Company B, another enterprise customer of the system. In addition, Company A employees may be matched with a node that is not a member of any enterprise customer. (See for example FIG. 4.) The system may allow for inter-company, and intra-company matches, either by allowing a node to so elect, by allowing the enterprise customer to set rules for all its members, or in any other way. Such indications may include meta data tagging on the node account information to indicate such qualities such as Company A, Company B, geography, etc.

FIG. 4 shows an example of an organizational matching flow chart. FIG. 4 shows the geographic algorithm that can be used to set limits, or preferences, of geographical location of matches, or to for example seek out or consider specific matches within certain geographical locations, or to, for example, seek out or consider specific matches between or within certain organizations or offices within organizations around the world 400, That geo data may be sent to the matching algorithm 402 to make the matches, or may otherwise be used in the matching process. The matching may also be based on minimizing a cost function that quantifies the financial costs and or require time to travel between said geographical locations, using geo variables such as optionally taking into account the desire or willingness of the participants to travel, their family status (e.g. having young children or not), difference in time-zones, information from onboarding, past behavior, type of travel available to each individual, time of year, individual age, etc. Examples include a match within the same organization A, 404. Another example is a match between a member of organization A and a member of organization B, 406. Another example is a match between a member of Organization A and a Private Consumer Node, 408. Another example is a match between two Private Consumer Nodes, 410.

Regarding FIG. 4 showing matching examples, Geographic algorithm; e.g. matches can be local, hyperlocal, national or international 400, Matching algorithm 402, Organization A—Organization A 404, Organization A—Organization B 406, Organization A—Private Consumer User 408, Private Consumer—Private Consumer 410.

Additionally, and for example, say Company A and B merge. The system can thus be used, and the algorithms and servers so configured, to match employees of Company A with those of Company B in order to increase the work culture and knowledge sharing. Boundaries and thresholds of geography may be set by the system in some examples, by using machine learning algorithms to predict which matches may most likely work better than others. The geo variables described above may be used in such algorithms to make predictions and matches based on geography.

Once matched by the system, a node may be connected to another node (or a group(s) of nodes) through any of various communication connections as described herein. This introduction may be by sending previously stored information for each node and either sending the information of the matched node, or by opening a communication channel by sending a message to both matched nodes. Such communications channels may be but are not limited to email, SMS, telephone, or web-based audio and/or video, the system's messenger system or a different manner decide by the system. This can be accomplished using existing equipment and techniques, for example by sending a default or a personalized introduction message to the other node or group(s), introducing the node. The message may be constructed by the system based on generic templates (e.g. requiring only certain identifying information to be inserted, or e.g. generated based on additional information about the node), or the system may poll the node to define a personalized introduction message. The polling may for example be done via the same interface as or a similar interface to the way the node was originally registered and onboarded. (See FIG. 3).

The nodes may be subsequently connected to each other. A calendar meeting may be scheduled by the system and may take place using any communication method, including by telephone, by video, by online audio, physically, or any other way. (See FIG. 3.)

For example, the system, through the data gathering, and as mentioned herein, may recommend a local coffee shop that is convenient for the matched nodes geography, schedule the meeting, make a reservation, and/or send a calendar invite with related information to the matched nodes.

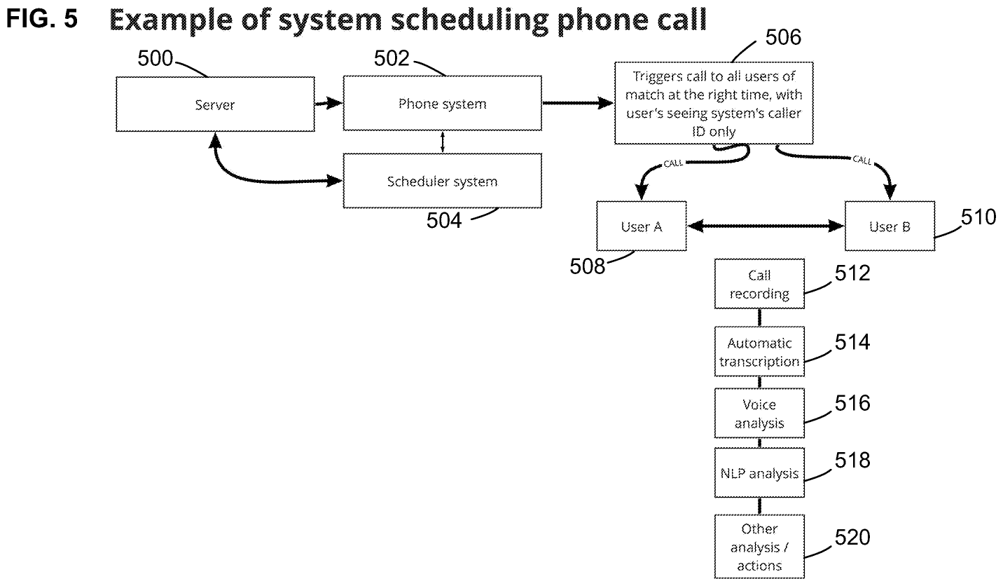

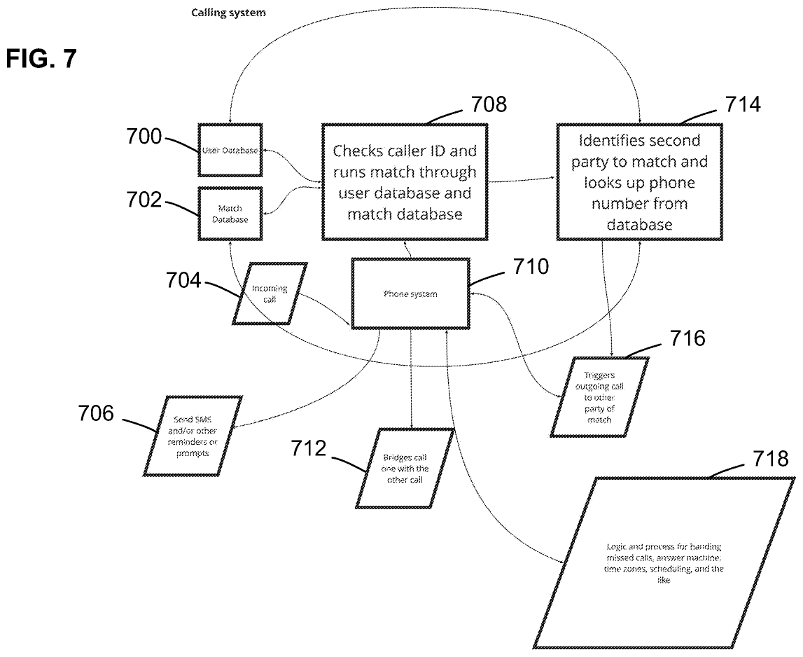

For example, as regards meeting over the phone, the system may automatically trigger the phone of each of the nodes to ring at a certain predetermined time which the system may know to be most convenient through its data gathering, and, upon the nodes picking up the ringing phone, connects them to each other. (See for example FIG. 5 and FIG. 7.)

FIG. 5 shows an example of system scheduled communications. In FIG. 5, the server 500 is in communication with a phone system 502 and a scheduler system 504. The phone system 502 may be configured to trigger a call to all nodes of a match at the scheduled time with nodes seeing the system caller identification information 506. The call to node A, 508 and node B, 510 may be arranged to make the connection. In some examples, the system may utilize call recording 512, automatic transcription of the voices 514, voice analysis 516, natural language processing algorithms 518, and/or other analysis of the communication, in any combination or permutation of the above or others 520. Regarding FIG. 5, Server 500, Phone system 502, Scheduler system 504, Triggers call to all users of match at the right time, with user's seeing system's caller ID only 506, User A 508, User B 510, Call recording 512, Automatic transcription 514, Voice analysis 516, NLP analysis 518, Other analysis/actions 520.

Additionally, the system uses or may use audio, and/or facial analysis to determine whether two or more nodes should be matched—or if they are matched, whether they are a suitable match—through voice, and/or facial, analysis, including but not limited to the nodes' synchrony (e.g. voice pitch to analyze how well nodes are matched).

A node may be matched with another node or a group of nodes instantly. For example, a node may tap or clicks on a button of a node interface of software running on the node local computer and/or application on a mobile smart device and that node is immediately matched and/or connected with another node or group of nodes. A node may also be matched with another node or a group of nodes at a later time by way of an opt-in system. The opt-in system allows a node to opt-in to being connected with another node or group of nodes at a certain time in the future. The opt-in system may also ask for data about the node, such as, for example, the availability of the node for a meeting with another node or group of nodes in an upcoming time period, such as for example the upcoming week. The opt-in system may also gather other data, such as data on a node's geography, time zone, and availability. The opt-in system may run matches once a week or more or less frequent, as may be set, for example, by the system, as chosen by the node, chosen by the enterprise node, or by any other manner. (See FIG. 3.)

Particularly as regards the opt-in system where a node chooses their availability over an upcoming period, for example over the upcoming week, the opt-in system is so structured to show relevant timeslots, in the node's time zone, and may show only a select set of timeslots so to increase the likelihood of a potential match, taking into account inter alia for example where a match can be between nodes in different time zones around the world. For example, the system may show a node in NY and a node in London a different time slot in order to increase the potential of them matching: a timeslot of 8 AM ET would be shown as 8 AM to a node in New York and as 1 PM to a node in the United Kingdom, thus increasing the pool of potential matches and allowing potential matches across geographies and cross-time zones.

For example, a different batch of timeslots is shown to a node on the East Coast of the US from that to a node in the Pacific region, though with some overlapping times that are identical when translated to a standardized time (as explained above), and are at a reasonable period of the day in both locations (i.e. e.g. during day-time in both location (e.g. not 4 AM)). The system is thus so designed to have as many corresponding timeslots, when translated to a standardized time, at reasonable periods of the day in as many time zones around the world as possible. Thus, the system enables nodes to match across the globe—and sets meetings with a node's new connection (or connections)—and does so at reasonable times of the day for all nodes concerned. The system may thus, in one embodiment, contain in the database a list of times and days using UTC time, which are chosen on a mathematical or other basis to be most optimal for people being available, around the world in the respective local time-zones. Similarly, the database may consist of two separate lists of times and days in UTC time, one optimized for nodes in the Eastern Hemisphere and one optimized for nodes in the Southern Hemisphere (or indeed more than two lists, each covering certain parts of the world, whether with or without some overlap between the lists so to enable, with the latter, a truly global opportunity to match). As the system picks up the location of the node (by, for example, IP address, node submission, computer time-zone setting, etc.), the server amends the database list and converts the UTC time to the local time of the node. It then provides those time slots on the interface on which the node chooses to elect, for example, a time and day for the upcoming meeting, in the node's local time zone. In addition, where the UTC time, when converted to the node's local time, results in a sub-optimal time for a meeting (e.g. 2:00 AM), the server hides (or, for example, greys out) those options from the node (e.g. all time slots falling, within the node's time-zone, between 0:00 AM and 07:00 AM).

Additionally, the system may, on the basis of the data it has obtained, determine that certain timeslots and/or days are more suitable for a specific node, or otherwise wish to, for whatever reason (e.g. to balance the number of potential matches across a week so to ensure an as large pool of candidates at any given time slot/day) show, hide, amend or otherwise change the options, and/or the visual in which the options are, shown to the node.

Additionally, the system may allow a node to opt-in to be matched and connected with a new connection without stipulating their availability or otherwise knowing their availability. The node or nodes would then be matched and introduced, and the system then gives the nodes the ability to subsequently schedule any follow-on meeting, be it by online video, online audio, telephone, a third-party communications provider such as Zoom (to which the system may be connected to), or in person.

Additionally, the system may allow a node to choose to have a wildcard match. The system may then override its usual algorithmic analysis and other usual processes and instead use full or partial natural serendipity, or some form of it including a random number generator, in connecting this node with another node or group of nodes.

Additionally, the system may display to a node one or more other nodes that are currently online, or have recently been online, on the system and allow the node to connect with such other nodes directly. In addition, the system may allow a node to choose which nodes to connect with, whether instantly or not, through a swiping of profiles mechanism (whether full, limited, or non-anonymized) and match with such person either unilaterally or only when both nodes choose to connect with each other. The system may additionally also allow a node to choose a specific other node to match with.

Additionally, the system may recommend and/or suggest suitable contacts to a node. The system may either show some information about that suitable contact or contacts, all information, or limited or no information. For example, the system may recommend and/or suggest a node be connected with a Senior Director at Company A based in New York City.

In addition to the above, the system may, without any action of a node, introduce said node to another node or group of nodes. For example, when a node completes their registration and onboarding process, the system may immediately match and introduce said node to another node (or group of nodes) or to new connections.

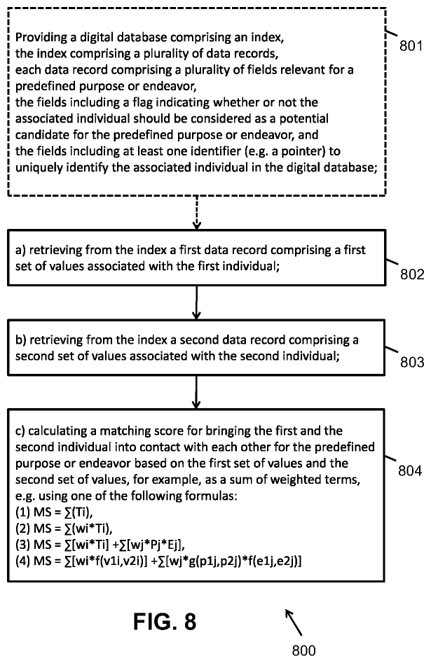

FIG. 8 is a flowchart of an example computer implemented method 800 of determining a matching score pertaining to a specific project.

The specific project match may include utilizing a particular index file 801 may be generated, containing data which is relevant or pertinent for the specific project. The index file may comprise a plurality of data records, each data record comprising a plurality of fields relevant for a predefined purpose or endeavor. The fields may include a flag indicating whether or not the associated individual should be considered as a potential candidate for the predefined purpose or endeavor as a previously stored information in the database. This field can also be used for example to indicate the availability or unavailability of certain individual during a certain period. The fields may further include at least one identifier (e.g. a pointer, or an email-address, or a national security number, or the like) to uniquely identify the associated individual in the digital database. In this way, more information about the individual may be found or retrieved from the digital database, once a matching candidate for the envisioned purpose or project or endeavor is found (for example, in case of a dating application, once a handful of potential candidates are found, more information about these candidates, such as e.g. additional textual data, a photo, audio fragments, video fragments, posts, etc. may be consulted, for making a final decision).

One method 800 of determining a matching score, may comprise one or more of the following steps: a) retrieving 802 from the index a first data record comprising a first set of values associated with the first individual; b) retrieving 803 from the index a second data record comprising a second set of values associated with the second individual; c) calculating 804 a matching score for bringing the first and the second individual into contact with each other for the predefined purpose or endeavor based on the first set of values and the second set of values, for example, as a sum of weighted terms, e.g. using one or more of the following matching formulas:

$$MS = \sum ( Ti ) , or \qquad ( 1 )$$

$$MS = \sum ( wi * Ti ) , or \qquad ( 2 )$$

$$MS = \sum [ wi * Ti ] + \sum [ wj * Pj * Ej ] , or \qquad ( 3 )$$

$$MS = \sum [ wi * f ( v 1 i , v 2 i ) ] + \sum [ wj * g ( p 1 j , p 2 j ) * f ( e 1 j , e 2 j ) ] , \qquad ( 4 )$$

wherein, MS is the matching score, Ti is a term related to normal data fields (or main data fields), Ei is a term related to extra data fields, wi is a weighting factor, f(.) is a correspondence function, e.g. a distance function, Pj is a fraction, and g(.) is a preference function.

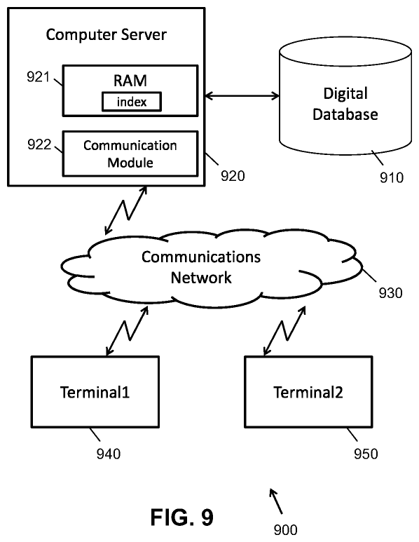

FIG. 9 shows an example block-diagram of a system 900, configured for finding two matching individuals for a particular purpose or endeavor, e.g. using a method as illustrated in FIG. 8, and when two matching individuals are found, automatically making communication connections with each other, e.g. by automatically establishing a telephone call, and/or a video conference between a first terminal 940 associated with the first individual, and a second terminal 950 associated with the second individual, over a communications network 930.

Network 930 may include any of a variety of wireless sub-networks that may further overlay stand-alone ad-hoc networks, and the like. Such sub-networks may include mesh networks, Wireless LAN (WLAN) networks, cellular networks, and the like. Network 930 may further include an autonomous system of terminals, gateways, routers, and the like connected by wireless radio links, and the like. These connectors may be configured to move freely and randomly and organize themselves arbitrarily, such that the topology of network 930 may change rapidly. Network 930 may further employ a plurality of access technologies including 2nd (2G), 2.5G, 3rd (3G) generation radio access for cellular systems 5G LTE, WLAN, Wireless Router (WR) mesh, and the like. Access technologies such as 2G, 2.5G, 3G, and future access networks may enable wide area coverage for wired or mobile devices, such as terminals 940, 950. For example, network 930 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. Network 930 may include virtually any wireless communication mechanism by which information may travel between Computer Server 920, comprising RAM 921 and a communication module 922, and another computing device such as the terminals 940, 950.

The index-file is preferably, but need not be, loaded completely in RAM, to enable highly efficient and super-fast searching and matching, e.g. using the algorithm of FIG. 8.

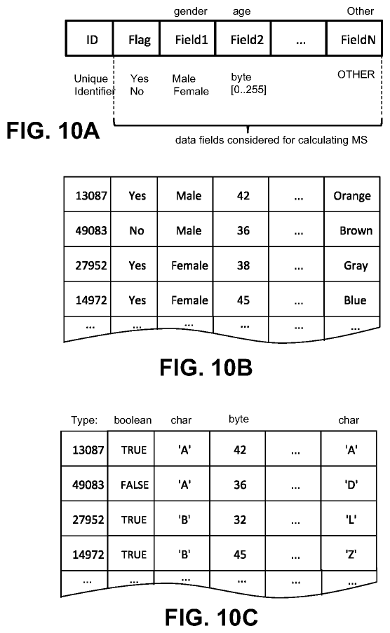

FIG. 10A to FIG. 10C show illustrative examples of data records, as may be used in embodiments of the present examples.

FIG. 10A shows an example data record having a unique identifier field, for uniquely identifying an individual in the digital database; and a Flag field for indicating whether the individual is to be considered or skipped; a gender field for indicating whether the person is male or female; an Age field for indicating how old the individual is, optional further fields indicated by three dots.

In the example shown in FIG. 10A to FIG. 10C, the ID field may contain a unique identifier, such as for example a unique number, an email-address, a telephone number, a social security number. The flag may contain a boolean value (TRUE, FALSE), or may contain a character value corresponding to TRUE or FALSE (in the example, the letter ‘A’ or the letter ‘B’. The Age field may contain an integer number in the range from 0 to 255, which can be represented by, for example, a single byte value. The hair color may be shown to the node in a drop-down list containing the following texts to select from, for example: Orange, Brown, Gray, Blue. This may be represented by four capital letters ‘A’, ‘D’, ‘L’ and ‘Z’, so to speed up the lookup and matching process, but of course another representation (e.g. using byte-values) may also be used.

It can be understood that an index file having only these fields is highly compact, and allows to represent thousands or even millions of individuals in only a small file. Of course, the index file has to contain fields which are relevant for the envisioned purpose or endeavor. If the purpose is for example, to form a group of people who identify as a certain sex of a certain age for a weekly sporting exercise, the other field may be less relevant, but instead a field representing a specific experience may be added. Further, for example, if the purpose is to contact people for a first particular selection, the system may enable the individual to not only indicate whether they prefer that yes/no, but also, to indicate whether they are more or less inclined on a sliding scale, or to indicate their capabilities on a scale from 0 to 5, 0 representing least inclined, to 5 most inclined, depending on the envisioned purpose.

The data for a particular index file may be extracted from the digital database(s), if all the relevant data is already present in the digital database(s). If not all data is available in the digital database, some of the data fields may be filled, while others may be left blank. When a particular individual signs-up for a particular endeavor, the system may show the data records, some or all, and the data values, some or all, some of which may be updated or completed by the node. If the node already signed-up for other endeavors, data may be retrieved from other index files. Likewise, if a node updates a certain data field, the system may update the corresponding data fields also in other index files and/or in the digital database(s).

In addition, the system may for example comprise a monitoring daemon module, configured to continuously or, preferably, intermittently detect such potential matches, by determining that a fruitful match could exist but has not yet been established. After detecting this, the monitoring daemon module may be configured to trigger the system to effectuate the new match.

In addition, when anew project (or purpose or endeavor) is created by a particular project manager or organizer, other people who are known in the overall database, but who were unaware of the new project, but which seem to have at least some of the right requirements or qualifications (e.g. in the above example of a weekly recreational sporting exercise), a person having relevant characteristics, may be notified of the new project.

We note that a problem often encountered with databases containing information about individuals is that they often contain data which is outdated. Embodiments of the present invention may gather data obtained from different places, and may compare the timestamps of that data, and/or compare the trustworthiness of that data, (e.g. data provided to an official institution, e.g. to a government or a bank) and keep the most recent and/or the most trustworthy data. In this way, the digital database may be kept up to date. In order to determine how trustworthy a particular set of data is, a curated list may be maintained, listing official institutions with high trustworthiness (e.g. either trustworthy as opposed to not trustworthy, or alternatively on a scale of trustworthiness—such a scale may be one-dimensional or multi-dimensional, e.g. taking into account both the type of institution and its age since establishment). The system may be programmed to expunge data that ages over a particular time threshold. In such a way, only renewed or updated data may be used for matching. Alternatively, or additionally, heuristics and heuristics thresholds may be utilized to estimate trustworthiness based on features of the data (e.g. does a data point align with other data points or is it an outlier).

Once a node (or a group of nodes) is matched by the system using algorithms and data as described herein, the system may notify the nodes of the match and introduce them to each other, and/or schedule a communication using the systems and methods described herein. In such examples, the communication connection may be established by the system itself. Such a notification and connection may be made by email, short message system (SMS), by internal messaging on the system software that is accessible to the nodes by node interface, or by other modes of communication.

Once notified of the match, the nodes (or group of nodes) may be put into direct communication automatically through audio, video, telephone, SMS, or some other method of communication by the system. In some examples, a timing or calendar system may be used to synchronize the communications by scheduling the communication at a predetermined time as designated by the system to be the best time for such communication. (See, for example, FIGS. 5 and 7.) This may also happen at a time designated by one or more of the nodes, during the onboarding process and/or at a subsequent interaction between the node and the system and/or through interaction between one node and another (or a group of nodes) through the system (or between the nodes manually outside of the system), or the communication may be triggered by one or more nodes automatically, which may also be instantaneously.

The introduction and connection may also be scheduled by geography if geographical data is part of the data submitted to the system during onboarding or other data gathering steps described above. The system may, through the collection of geographical and other data, not only use that data in creating the most suitable matches but also coordinate, be it by recommendation, by advanced booking, or through any other means, a physical meeting location for the match (e.g. a local coffee shop).

### Additional Detail and Further Elaboration on Matching

As noted, according to a first aspect, the present invention provides a computer implemented method of determining a matching score when bringing at least a first and a second node into contact with each other using a digital database comprising digital information associated with a plurality of nodes, the digital database comprising an index, the index comprising a plurality of data records, each data record comprising a plurality of fields relevant for the predefined purpose or endeavor, the fields including a flag indicating whether or not the associated node should be considered as a potential candidate, and the fields including at least one identifier (e.g. a pointer) to uniquely identify the associated node in the digital database; the method comprising the steps of:
a) retrieving from the index a first data record comprising a first set of values associated with the first node;
b) retrieving from the index a second data record comprising a second set of values associated with the second node; and
c) calculating a matching score for bringing the first and the second node into contact with each other for the predefined purpose or endeavor based on the first set of values and the second set of values.

Such system may be used, for example, for dating applications, or a project for bringing people together for a particular education or training program, for a professional meeting, for a client-customer discussion, for matching people to participate in a certain sport, etc.

Each data record comprises a plurality of values, each value corresponds to a particular characteristic; e.g. in case the endeavor is a doing a survival trip, parameters or characteristics related to physical strength or endurance may be relevant.

As another example, in case the purpose is to bring together people from two different departments of a large company in order for them to better understand the internal workings of the company and stimulate internal cooperation, characteristics such as similar seniority, interests in same (non-work related) areas, gone to same university, etc. may be relevant, but in order to stimulate cross-fertilization and keeping the contact interesting, a good match may include at least some differences, such as e.g. expertise in different areas, living in different cities, etc.

In the example above, the flag indicating whether or not the associated node should be considered as a potential candidate for the purpose of matching may be set by the company, but in other examples, e.g. a dating application, the flag may be set by the node himself or herself. This flag may for example be implemented as a boolean value, and may hold one of two possible values e.g. yes or no, but of course, the present invention is not limited thereto, and may also be implemented using a byte (8 bits) or a letter. The flag can be used to simply skip certain nodes from the specific project. This can be implemented for example by setting the matching score to 0% if the flag indicates that the person should not be considered. It is an advantage to use an index with the flag field, because it allows to simply copy the index and to reset or overwrite the values of the flag fields when performing a similar activity or endeavor on a regular basis, without having to rebuild the index every time, which is very time-consuming task.

The size of the index file largely depends on the number of fields required or used or considered for a particular project. The number of fields may range for example from a value of about 5 when the project is bringing persons identifying as a certain sex of a certain age bracket into contact with each other for a weekly swim in the public swimming pool of a particular city, to a value larger than 20 or larger than 50 for a dating application, but of course the present invention is not limited thereto, and a number of fields can also be less than 5, or larger than 20, and any value in between.

The digital database may comprise for example contact information such as e.g. telephone number, an email address, a reference to a Facebook page, a reference to an Instagram account etc. Alternatively or additionally, the digital database may comprise personal data such as age or date of birth, height, weight, hair color, smoking preference, drinking preference, interests, political interests, religious interests, investment interests, sports interests, education, employment, mother tongue, second language, country of birth, programming skills, technical skills, social skills, hobbies, vacation preferences, marital status, other data, etc. Alternatively or additionally, the digital database may comprise non-personal data, such as e.g. textual publications made by this person, a publicly available audio file or video file related to this person, etc.

It is noted that the same digital database may be used for many different projects. Each project would preferably use its own index file, and optionally additional data, such as e.g. particular weighting factors (see further), etc.

In an embodiment, step c) comprises: setting the matching score to 0% if the flag field indicates that the node should not be considered, and otherwise: calculating the matching score as a sum of terms, or as a weighted sum of terms, each term being determined (e.g. calculated) using a predefined correspondence function.

As noted, a sum of terms can be expressed mathematically as: MS=Σ(T).

A weighted sum of terms can be expressed mathematically as: MS=Σ(wi*T).
wherein Ti=f(v1, v2), where MS is the matching score, Ti is the i-th numbered term, and wi is the weight factor of the i-th numbered term, f(.) is the correspondence function, v1 is the first value, and v2 is the second value.

The correspondence function may be a generic function or a dedicated function, depending on the field and/or on the particular purpose or endeavor.

An example of a generic function is closer to an exact match, which may be implemented for example by assigning the value of 100% if the two values are identical, and by assigning the value of 0% if the two terms are different.

Another example of a generic function may be a distance function which can be applied for example to determine a correspondence or similarity between two integer values such as for example the height of a person, or the weight of a person. Such a function may be implemented for example as a predefined constant (e.g. 100%) minus the absolute value of the difference between the two values multiplied by a certain factor, clipped to zero if negative.

An example of a dedicated function may e.g. be a specific function to take into account the easiness or difficulty of physically travelling between two locations. This may be relevant e.g. when the two users are to physically meet each other. The dedicated function may for example take into account the availability of an airport or a train station, and/or the time required to travel (e.g. in number of hours), and/or the monetary cost of such travel, or combinations thereof. Such a function may for example be implemented (e.g. programmed) specifically for a particular application and/or for a particular company.

In an embodiment, the values of the index are alpha-numerical values.

With alpha-numerical values is meant: characters 0 to 9 and/or from A to Z and a to z. For other scripts than the Latin alphabet, this may of course be localized, e.g. to Greek or Cyrillic alphabet. In that case, it is preferred to store the alpha-numerical values using a suitable encoding system, e.g. Unicode UTF-8 or similar.

It may be an advantage that the data records of such an index file are extremely compact, e.g. comprising only one byte per field. As an example, a data record of this type having a flag (1 byte) and a pointer to the database (e.g. 4 bytes), and 20 fields (20 bytes) only requires 25 bytes per node, thus an index file of 100,000 (one hundred thousand) nodes requires only 2.5 megabytes (MB) of memory, which can be easily held in RAM of modem days computers or servers, typically having multiple gigabytes of RAM at their disposal. Searching in RAM can be extremely fast, and thus searching and finding two (or more) matching nodes for a particular purpose can be extremely fast, and does not require access to the digital database itself. The latter may be stored in a mass storage device, or may be distributed over multiple storage devices, interconnected via a network, or in a cloud or distributed computing environment.

In some embodiments, only uppercase letters are used, or only lowercase letters.

A person skilled in the art of software techniques, will appreciate that fields such as hair color can effectively be implemented using a selection list, e.g. using a drop-down box. The list may contain for example the following items: black hair, gray hair, white hair, brown hair, blue hair, and in the index file, each of these can be assigned a letter, for example black hair may be represented by character A, gray hair may be represented by character B, etc. If an exact match is used as the correspondence function for this field, it does not matter which letter is assigned to which hair color, as long as each color is assigned a different letter. However, if a (standard) distance function is used as the correspondence function, (e.g. determined as the distance between two letters in alphabetical order), assignment of letters to hair colors such as the following may be more appropriate: black=A, brown=D, white=L, blue=Z. Such an assignment automatically takes into account that black hair and white hair are very different, and that black and brown hair are somewhat similar, and that blue hair is rather exotic. If the application requires a more sophisticated correspondence function, it is of course also possible to implement a dedicated function that assigns a particular matching score to each specific combination of two values. This example illustrates that an index comprising a plurality of data records, wherein the fields are represented by alphanumerical values, can be used for a wide range of applications. But of course the present invention is not limited hereto, and an index file also comprising other types of data, such as for example integer values in the range from 0 to 255 (which can be represented by 8 bits), and/or integer values in the range from 0 to 65,535 (which can be represented by 16 bits), or text strings comprising only two characters (e.g. country codes, or representing states) may also be used.

In an embodiment, the weight factors are predetermined values.

The weight factors may have predefined values, which values may depend on the particular purpose or project. They allow to give more weight to certain fields or parameters over other. The weight factor may be chosen solely dependent on the envisioned purpose, independent of any user or other preferences or settings.

This embodiment (with predefined values for weight factors) may be very suitable, for example, for an application to bring two people from two particular countries into contact with each other as a pen friend. In this example, the field mother tongue may be set as a must-have value, requiring an exact match, but in order to better communicate, it may be helpful that the other person also understands the mother tongue of the other person, thus the field (and thus the term) related to second language may be given more weight than fields like age. As another example, when the same fields are used for a dating application, the fields (and thus the terms) related to age may be given more weight than second language. These examples illustrate that the rate factors are typically chosen differently for different applications.

In an embodiment, the weight factors are dynamically adjusted.

In this embodiment, the weight factors may be dynamically adjusted, e.g. manually, by a data-analyst, or automatically, using a Neural Network, e.g. taking into account feedback obtained from nodes of the systems, when asked about their (subjective) impression of the quality of the match.

In a particular embodiment, the weight factors may be determined using a deep learning technique, designed to find optimal values of the weight factors for the particular purpose, using the data of previous participants to the particular program or endeavor, and the feedback on the quality, as a training set.

In an embodiment, the data records of the index further comprise one or more extra data fields related to the other node to be matched, and one or more preference fields associated with respective extra data fields, the preference fields holding preference data indicative of a preference level for the other node to have the value indicated in the extra data field for the predefined purpose or endeavor; and step c) comprises: calculating the matching score (MS) as a weighted sum of terms, wherein the weight factor of each term is either a predefined weight factor for the predefined purpose or endeavor, or is a predefined weight factor multiplied by a predefined preference function of the preference value of the first node and the preference value of the second node for the respective extra data field.

This can be expressed mathematically by the following set of formulas:

$$MS = \sum [ wi * Ti ] + \sum [ wj * Pj * Ej ] , or as :$$

$$MS = \sum [ wi * f ( v 1 i , v 2 i ) ] + \sum [ wj * g ( p 1 j , p 2 j ) * f ( e 1 j , e 2 j ) ] ,$$

where MS is the matching score, i and j are indexes,
Ti is the i-th numbered term applicable for normal data fields (also referred to herein as main data fields, i.e. data fields holding a property or characteristic of the node itself, i.e. not an extra data field), wi is the weight factor of the i-th numbered term, f(.) is the correspondence function applicable to that data field, v1i is the first value (the value of the respective main data field in the first data record), and v2i is the second value (the value of the respective main data field in the second data record);
and wherein Ej is the j-th numbered extra term applicable for extra data fields (also referred to herein as secondary data fields, i.e. data fields holding a (e.g. desired or required) property or characteristic of another node to be matched with the first node, wj is the weight factor of the j-th numbered extra term, f(.) is the correspondence function applicable to that extra data field, e1i is the first value (the value of the respective secondary extra data field in the first data record), e2i is the second value (the value of the respective secondary extra data field in the second data record), g(.) is a predefined preference function, (an example of which will be given below), p1j is a preference value in the first data record associated with the j-th numbered extra data field, and p2j is a preference value in the second data record associated with the j-th numbered extra data field.

This can be interpreted as follows: main data fields are assigned a predefined weighting factor which does not take into account a preference level of either node, whereas extra data fields are assigned a variable weighting factor wj*g(p1j,p2j) which does take into account a preference level of both nodes for that particular extra data field.

Preferably, each project (or endeavor) uses its own index file, having its own structure. As mentioned above, the structure comprises at least one flag for indicating whether a particular data record should be considered or not (e.g. is active or not, at a given time), and at least one (normal) data field. Optionally the data record may also comprise one or more extra data fields and an equal number of associated preference fields.

As an example, if the purpose of the project is to find two people inside a large organization that need to cooperate on a short-term project, where no personal contact between the people is required, and where a particular combination of skills is of primary preference for the success of the project, the project manager may decide not to use any extra data fields, meaning that all weight factors are predefined, without taking into account any preferences of the nodes.

As another example, if the purpose of the project is to find two people inside a large organization that need to cooperate on a long-term project (e.g. about 2 years), and wherein the people have to regularly meet each other in person, one or more extra data fields related to personality traits or social skills or personal interests or preferred musical genre or the like, may be used.

In an embodiment, the preference values may be selected from a list containing only three values: 100% (important or must-have), 50% (preference but no-absolute-must), and 0% (not important or don't-care).

In a variant, the preference values may be selected from the list containing only three values: 75% (strong preference), 50% (medium preference), 25% (low preference);

In another variant, the preference values may be selected from a list containing only four values: 100% (important or must), 75% (strong preference but no absolute must), 50% (preference), and 0% (not important or don't-care).

Of course, the present invention is not limited to these examples, and it is also possible to use e.g. 5 different preference levels (e.g. number 1=low preference, number 5=strong preference), or to use 10 different preference levels (e.g. number 1=low preference, number 10=strong preference), or any other scale.

The preference function g(p1,p2) is preferably chosen such that:
i) the full weight, i.e. wj*(100%), is assigned to the term Ej, if one or both of the nodes considers the item (or characteristic) associated with the corresponding extra data field important. This may be surprising to the reader, but scientific studies have shown that conflicts may arise especially in areas considered important by one person, but not (or not at all) by the other person;
ii) a zero weight, i.e. wj*(0%) is assigned to the term Ej if both nodes consider the item to be not-important;
iii) a fraction of the full weight, e.g. a fraction in the range from 2% to 98% is assigned to the term Ej, if at least one of the preference values corresponds to preference or strong preference, or any other value between must and don't-care.

As an example, in a particular implementation wherein the preference values can be selected from a list containing only three values not important, preferred, and must-have, the preference function g(p1,p2) may for example be implemented using the following look-up table:

| First preference | Second preference | Multiplication factor |
|---|---|---|
| value (p1j) | value (p2j) | of the weight: |
| 0% (not important) | 0% (not important) | 0% |
| 0% (not important) | 50% (preferred) | 33% |
| 0% (not important) | 100% (must) | 100% |
| 50% (preferred) | 0% (not important) | 33% |
| 50% (preferred) | 50% (preferred) | 66% |
| 50% (preferred) | 100% (must) | 100% |
| 100% (must) | 0% (not important) | 100% |
| 100% (must) | 50% (preferred) | 100% |
| 100% (must) | 100% (must) | 100% |

Of course, the present invention is not limited to this particular preference function, and other preference functions can also be used.

According to a second aspect, the present invention also provides a computer implemented method of searching in a digital database at least two matching nodes for a predefined purpose or endeavor; the digital database containing digital information related to a plurality of nodes who have engaged for being contacted for a predefined purpose; the digital database comprising an index, the index comprising a plurality of data records, each data record comprising a plurality of fields relevant for the predefined purpose, the fields including a flag indicating whether or not the associated node should be considered as a potential candidate for the predefined purpose or endeavor, and the fields including at least one identifier (e.g. a pointer) to uniquely identify the digital data of the associated node in the digital database; the method comprising the steps of: a) obtaining from the index a first data record for which the flag-field indicates that the associated node is a potential candidate for the predefined purpose; b) initializing a list of potential candidates and a matching score; c) for at least a subset of the records in the index, performing the following steps: d) retrieving from the index a second data record; e) calculating a matching score between the first data record and the second data record using the above-described method of the first aspect; f) updating said list in order to keep potential candidates having a matching score higher than a predefined threshold, or in order to keep a limited number (e.g. of at most 5, or at most 3, or only 1) candidates with the highest scores; g) providing the list of matching candidates, and their matching score.

If only one best matching candidate is sought, the list may comprise only a single reference.

The method of the second aspect can in principle be performed on a standard computer or on a standard server, comprising at least one processor (e.g. a Pentium chip running at a frequency of at least 1 GHz), and comprising or connected (directly or indirectly, e.g. via a network) to a storage medium which is sufficiently large (e.g. at least 1 Terabytes) for storing said digital database. Preferably, the computer or server also has a sufficient amount of RAM (e.g. at least 128 Megabytes) for storing at least a portion of the index file. More preferably the computer or server has a sufficient of RAM (e.g. at least 1 Gigabytes, or at least 4 Gigabytes) for storing the entire index, as this allows an even faster search.

According to a third aspect, the present invention also provides a computer implemented method of searching in a digital database at least two matching nodes for a predefined purpose, and bringing these at least two nodes into contact with other, comprising the steps of: i) searching in a digital database at least two matching nodes for the predefined purpose using the method of the second aspect; ii) retrieving contact information for each of said at least two nodes from the digital database; iii) finding a suitable time slot for establishing a contact between said at least two nodes; iv) setting up or establishing a live communication between the at last two nodes at the suitable time slot.

Depending on the specific type of communication, the computer or server is preferably operatively connected to a telephone switching network and/or to the Internet.

Step iii) may comprise: checking the availability of each candidate, e.g. by automatically checking their calendar or by proposing a few possible time slots to the candidates on a web-page, which the candidates have to confirm, or in any other suitable manner.

In an embodiment, step iv) comprises: setting up or establishing a telephone call or a video call from a computer server to each of said at least two nodes.

Preferably, the telephone call is set up in such a way that the caller ID's of the two nodes are not visible to the other party. In this way, anonymity can be improved.

In an embodiment, the computer implemented method of the first aspect, further comprises one or more of the following steps:
by a computer server, receiving data from a first node by a registration webpage API, and updating the digital database;
by the computer server, receiving data from the first node by an onboarding questionnaire and updating the digital database;
by the computer server, receiving data regarding geography of the first node, and updating the digital database;
by the computer server, receiving data regarding online web browsing activity of the first node, and updating the digital database;
by the computer server, recording audio data of a voice of the first node to create audio data of the first node, and updating the digital database;
by the computer server, applying natural language processing to input from the first node, and updating the digital database;
by the computer server, storing all of the data regarding the first node in a data storage, and updating the digital database;
by the computer server, receiving data from a second node by a registration webpage API, and updating the digital database;
by the computer server, receiving data from the second node by an onboarding questionnaire, and updating the digital database;
by the computer server, receiving data regarding geography of the second node, and updating the digital database;
by the computer server, receiving data regarding online web browsing activity of the second node, and updating the digital database;
by the computer server, recording audio data of a voice of the second node to create audio data of the second node;
by the computer server, applying natural language processing to input from the second node, and updating the digital database;
by the computer server, storing all of the data regarding the second node in a data storage, and updating the digital database;
using the data regarding the first node and the data regarding the second node to determine a match; and if a match is determined, sending a communication to the first node and the second node to facilitate communication between the first node and the second node.

According to a fourth aspect, the present invention also provides a system comprising: a computer server comprising a computer program comprising executable instructions for performing a method described herein, the computer server comprising or connected to a storage device storing said digital database and said index, and comprising a communication module for connecting the computer server to a network (e.g. a telephone network, a LAN-network, a WAN-network, an intranet of one or more companies, the Internet, etc.); a first and a second terminal device (e.g. a laptop computer, a desktop computer, a telephone, a smartphone, a tablet computer, a handheld terminal, etc.) comprising or connected to a microphone (e.g. a built-in microphone, or a microphone of a headset connected to the device), and comprising a communication module for connecting the respective terminal device with the network, and being configured (e.g. in hardware and/or in software) for communicating at least voice over the network via said microphone.

Preferably, the first and the second terminal device further comprise, or are communicatively connected to a digital camera or a webcam, and to a display, and preferably the terminal device(s) is/are further configured for communicating also video captured by the digital camera or webcam over the network.

In a particular embodiment, the first and/or second terminal device may be a personal computer, for example a laptop computer, comprising a storage device (e.g. a hard disk), and comprising a software application such as e.g. Skype® or Zoom® or Teams®, a Voice-Over-IP application, etc.

### Inter-Organization Connections

As noted, in addition, and alternatively, the system may use algorithmic analysis to create matches between members of different organizations. Using data gathered as described herein, the system may be able to identify nodes as belonging to a certain organization and to label such nodes as such. The system may do so by matching an email address, phone number or other data point to that of an organization and thereby identify and/or label such node as being part of said organization, or through another way. This allows, as further explained below, the system to match nodes not only within their organization but also between different organizations, where both organizations' rules are set to allow for that (e.g. a node who is with Company A may be matched with, introduced to and connected with a node with Company B where the system determines that such match is the most suitable or otherwise preferred match).

In order to do so, the system may comprise at least one processor configured to obtain the email address, phone number or other data point in question (e.g. via a communication I/O interface), to obtain the range of email addresses, phone numbers or other data points belonging to the organization, and to compare these in order to determine whether the former is included in the latter. At least one processor may be configured to strip away irrelevant elements, e.g. the node identification of an email address, i.e. the part before and up to the @-sign, and maybe even parts of the domain name of the email address, i.e. the part after the @-sign, e.g. if a company X uses email addresses divided by company division such as @division1.X.com and @division2.X.com, but should not operate with overly fuzzy matching rules in order to prevent finding faulty matches. For example, when a node seeks to register with the system (in order to benefit from its services), a server may obtain, for example, the email as submitted by the node and undertake a look up in the database to confirm whether or not that piece of data, in this case the email address domain, is verified to belong to any specific organization. Similarly, an organization (e.g. a company) may for example use a relatively large number of consecutive phone numbers over a certain range, and a person from that organization (e.g. from the human resource department of the company) may provide this telephone range to the computer server at any time, e.g. at the time when registering one or more of its employees for a certain project or endeavor, e.g., if the range is a consecutive series, by providing the first telephone number and the last telephone number of the consecutive series. As the computer server has access to this range, it can determine that a person having a telephone number in the specified range belongs to company A. Similarly, the system can verify that a node belongs to a certain organization through other means, such as by obtaining data from the company's website or employee rosters, the individual's online activity, company IP address, etc.

The system's onboarding process (as well as the actual matching system, as will further be elaborated on later) may be tailored to the objective of the node seeking to be matched with, introduced to, and connected with another node (or group of nodes or other item of information). For example, where the purpose is to create professional relationships between nodes (e.g. within an organization or across different organizations), the onboarding may consist of providing specific inputs depending on the type of node. The system may recognize whether a node is with a recognized organization (e.g. an organization with whom the system has a partnership or some other agreement, for example, a paid enterprise-wide node agreement, and as described herein). (See, for example, FIG. 2).

FIG. 2 shows an example of Approved node identification using the system and methods described herein. In the example, Node on a software interface 200 submits data on a signup page 202. This data is sent to a server 204 and could be any number of onboarding data as described herein. The system then checks whether a node is an Approved Corporate Node/Approved Non Corporate Node/Non-Approved Node and cross references node data with Databases and Rules for Approved Corporate Nodes, and others 208. In some examples, Databases of rules for Approved Corporate Nodes, (e.g. lists of approved email domains) may be used 206.

As shown in the example set out on FIG. 2, if the node is Approved Corporate Node, the Approved Corporate Node Onboarding Process begins 212. If the Approved node is Non Corporate, but Approved, the Approved Non Corporate Node Onboarding Process begins 214. If the node is not approved, the System places the Node on a database of waitlisted nodes 216. Finally, in some examples, the system may allow a node to enter a code, and if the Code entered by the node is correct, 220, then the system may utilize the Approved Non Corporate Node Onboarding steps 214. If the code is incorrect, the system may revert to the database of waitlisted nodes 218. In some examples, a correct code may be one on an approved list and stored on a database, and allows nodes to register with the system.

As described in FIG. 2, Approved user identification, user on mobile app/webpage (table/mobile/computer) 200, submits data on signup page 202, System's server 204, checks whether user is Approved Corporate User/Approved Non-Corporate User Cross-references user data with Database of Rules for Approved Corporate Users 206, Database of Rules for Approved Corporate User (e.g. list of approved email-domains) 208, Approved User? 210, Approved Corporate User Onboarding process 212, Approved Non-Corporate User Onboarding process 214, System places User on database of Waitlisted users 216, System brings User to waitlist page, and provides User opportunity to input code 218, If code entered, system assesses whether code is correct 220, Run by system's servers and databases and updated throughout process 222.

The system can do so by matching information the node submits through the node registration and/or onboarding (e.g. email address, phone number, or other data point(s)) and checks whether that matches a system-recognized organization. If so, the system allows the node to proceed with the registration and onboarding. If the system recognizes that this node is not with a recognized organization, the system provides an alternative onboarding process suitable for nodes that are not members of a recognized organization, or, if the system is so configured, to a waitlist page. Such a waitlist page may allow for a user to submit a code or some other piece of data, upon which, if the system is so configured, may allow such node to continue with the node registration and onboarding. The system may then label such a node as an independent node (i.e. anode that is not with an organization recognized by the system) and take that into account, inter alia, for example, when creating matches between nodes or groups of nodes.

In terms of other sources of data, the system may use data provided by the enterprise node or other node, data that is publicly available, data that is not publicly available, (but e.g. available on the intranet of the enterprise), and other sources of data. It may also include feedback from nodes, data gathered through use of the system, and the like.

The system may also provide for different enterprises different and/or personalized security features, publishing permissions, viewing permissions, and the like, suitable to different organizations.

### Multi-Enterprise Network, and Intranet-Like Enterprise Communication Platform

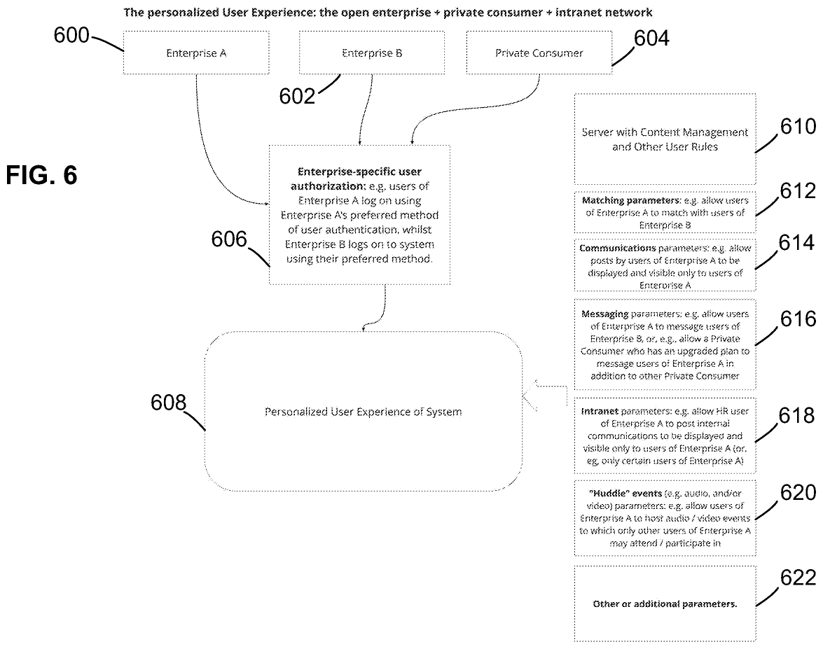

The system may serve as an enterprise network, and simultaneously as an enterprise network of other enterprises, and as a consumer non-enterprise professional or other social network, all at the same time (see for example FIG. 6.),

In addition, such system and may include also features allowing for the viewing of, searching of, communicating with, and the creating of, matches (e.g. new connections) as described herein, and/or other features (e.g. a looking for wall as described herein), and for example thus serve as a one-stop technological solution, including combining various methods and systems described herein.

Enterprise networks are generally platforms that facilitate communication and collaboration amongst similar nodes within the same organization. They may include a variety of features and functionalities (such as newsfeeds, messaging, etc.).

Usually, for example, enterprise networks are limited to nodes of a single enterprise. For example, the use of and access to an enterprise social network of Company A is limited to employees of Company A.

Usually, a consumer non-enterprise professional or other network is open to all nodes and is not affiliated with any enterprise.

There are no systems currently that combine an enterprise network (e.g. a network catered to employees of company A and controlled by company A) across numerous enterprises (e.g. an enterprise social network which allows both company A and company B employees to use, and, for example, managed by each respective company), Additionally, there are none that combine also a personal network (e.g. a cross-enterprise network allowing its use by non-enterprise affiliates nodes, for example, a freelance person).

The system may combine individual and/or all elements of both an enterprise network and, at the same time, of a consumer non-enterprise professional or other social network. In addition, the system may combine at the same time numerous enterprise social networks together.

The system is created so that it can be used, for example, by employees of enterprise A, employees of enterprise B, and non-affiliated consumer users, all at the same time. All such nodes are able, within the parameters of rules set by individual nodes, enterprise nodes, or set on any other basis, be matched with each other, connect with each other, follow each other, interact with each other, see each others' posts, comments, likes, and the like, and any other form of interaction.

The system may also provide for different enterprises different and/or personalized security features, publishing permissions, viewing permissions, and the like, suitable to different organizations.

In addition, the system may combine the above with features generally provided, and/or used, by enterprises to employees through a traditional intranet portal—e.g. internal communications, employee information, and the like. For example, the system may allow for nodes of different enterprises to browse each other's posts on a wall, whilst still seeing internal communications addressed to the browsing node by that user's employer, where such communications are set to be visible only to nodes of that enterprise node and not visible or otherwise accessible to any other node. Thus, for example, the system has the best of all worlds: high engagement, personal network, enterprise network, inter-enterprise network, and an avenue to obtain internal communications and other employee information and enterprise specific communications and services. The system may also integrate, whether fully or otherwise, the above with an enterprise's existing and/or traditional intranet.

FIG. 6 shows an example flow chart depicting the personalized node experience, the open enterprise, private consumer and intranet network.

FIG. 6 shows Enterprise A 600, Enterprise B 602, and Private Consumer 604 all in communication with the system where enterprise specific node authorization may occur 606. For example, nodes of Enterprise A log on using their preferred method while nodes of Enterprise B log in using their preferred method. Once logged on, the system may be further personalized 608. Options of personalization include but are not limited to any combination or permutation of the following from the server with content management and other rules 610: matching parameters that allow nodes of enterprises to match between enterprises 612; communication parameters that allows posts, or other communications, by nodes in an enterprise to be limited and available only to those within the same enterprise and not to anyone outside 614; messaging parameters such as allowing nodes of different enterprises to communicate or allow a private consumer for example who has upgraded to message members of enterprise A and another private consumer 616; allow certain credentials to a node in an enterprise to pose internal communications only available to members of that communication 618; huddle events allowing audio/video communications for members of an enterprise to communicate between themselves and/or with others 620; and/or other additional parameters 622.

Regarding FIG. 6, the personalized User Experience: the open enterprise+private consumer+intranet network, Enterprise A 600, Enterprise B 620, Private Consumer 604, Enterprise-specific user authorization: e.g. users of Enterprise A log on using Enterprise A's preferred methods of user authentication, whilst Enterprise B locks on to system using their preferred method 606, Personalized User Experience of System 608, Server with Content Management and Other User Rules 610, Matching parameters: e.g. allow users of Enterprise A to match with users of Enterprise B 612, Communication parameters: e.g. allow posts by users of Enterprise A to be displayed and visible only to users of Enterprise A 614, Messaging parameters: e.g. allow users of Enterprise A to message users of enterprise B, or, e.g., allow a Private Consumer has an upgraded plan to message users of Enterprise A in addition to other Private Consumer 616, Intranet parameters: e.g. allow HR user of Enterprise A to post internal communications to be displayed and visible only to users of Enterprise A (or, e.g. only certain users of Enterprise A) 618, Huddle events (e.g. audio, and/or video) parameters; e.g. allow users of Enterprise A to host audio/video events to which only other users of Enterprise A may attend/participate in 620, Other or additional parameters 622.

### Reporting Mechanism

Systems and methods here may include a reporting system whereby a node may send a communication to report or otherwise share information with, and escalate an issue to, the administrators of the system, another node's emergency contact, a node's organization, or other communication target.

For example, if a node is matched with another node and the node identifies a risk of the other node having a health emergency or issue, the system enables the node to report this immediately to relevant stakeholders (e.g. to a doctor or a nurse) in an automated manner. This can be done in numerous ways including by call, for example by any of the systems described herein, by SMS, email, or any other way. A particular embodiment may also be an online link (or platform link) that allows the node to send a message to the central database that in turn shares this with the relevant stakeholders (e.g. family members, siblings, nurses, home care center, etc.). The system may identify relevant stakeholders by the contents of the link, by data collected from the registration and/or onboarding, other data stored in the databases, or from any other source. The system, or alternatively and/or additionally the link, may also notify local doctors and hospitals, using location identification described herein, or by means of other data sources. Daily, weekly, monthly, etc. reports, which include past messages and contents made and included by the users or one of the users of the system, may be downloadable on the relevant platforms, and/or emailed, or otherwise made available to stakeholders.

In another particular embodiment, where, for example, the system also comprises a dedicated terminal (e.g. handheld device) with an emergency button. When the emergency button is pressed, the dedicated terminal automatically makes contact with a doctor or a nurse, or another caregiver. In order to do so, the dedicated terminal may for example be connected to the system prior to the nodes being brought into contact with each other. Also, in a preferred embodiment, the dedicated terminal may be a smartphone or a wearable device such as a smartwatch of the node, or an app on such device, and the functionality of the emergency button may be implemented in software by displaying an obviously and clearly visible button on the display of the smartphone or wearable device, and by configuring the displayed button to, once clicked, automatically execute the emergency escalation.

In addition or alternatively, the systems and methods may be used to conduct an audio data analysis, such as analysis of the voice and/or image analysis such as facial appearances and mannerisms, and/or other elements, to identify an actual or potential health or other issue of a user, and subsequently flag that to the user, and/or other relevant stakeholders and/or otherwise use this data for matching purposes, and/or other purposes. For example, the system may be trained to identify coughs and suggest next steps (e.g. to seek medical attention or to take a certain throat lozenge).

### Wall, Feed and Information Posting Feature

The system may also include a wall (e.g. news and/or update feed) where audio, video, text, photos and/or other material may be available. The wall may comprise one or more webpages, e.g. a homepage with buttons or pull-down menus allowing access to other webpages. Some or all of these webpages may be available only for individuals working at a particular enterprise or enterprises, or nodes registered for a particular project or endeavor, or some data on such pages may only be visible to certain nodes (as may be set by access rights, and as described further herein).

Access to the information posted to a wall may be different depending on the rules set by the system for the enterprise customer and its members, by specific rules set by a node, or on any other basis. This may be implemented for example using access rights, which may, for example, be associated with the login-ID. Access rights are straightforward to implement on a general-purpose computer. For example, a post by an executive at Company A, an enterprise node of the system, may be set to be visible only to Company A employees. Whilst an employee of Company B who is connected with a Company A employee on the system may see posts of said Company A employee on their wall, they will not see the post by the Company A executive described above. Additionally or alternatively, the visibility of certain data may be implemented by grouping all data of individuals of a certain Company on a certain webpage, and accessing or denying access to that webpage.

Automated and/or Tailored Internal Communications and/or Other Messages

In addition, and for example, the system may schedule for an enterprise node's internal communications to be sent or otherwise made visible to their nodes automatically. The system may thus automatically provide internal communications to a node(s), and share such communications by message on the system on the wall, or through another manner. For example, the communications shared with anew employee of an enterprise node of the system may be tailored by the system to improve the onboarding experience of said node, for example, with pre-created communications being sent out in a personalized manner to such node. In addition, for example, the system may take that data into account when creating matches for said node so to improve the employee experience.

The system may also include sales intelligence solutions. The system may also provide similar services geared to HR professionals and services, and recruiters, and others.

### Huddles: Audio and Video Events

The system can be used in combination with any of the systems described above, in whole or in part, or on its own.

Using data gathered in one or more manners as described above, the system uses algorithmic and other methods to connect nodes by live and/or prerecorded audio and/or video conversations about topics, and/or with nodes (audience and/or speaker(s)) that the system determines is a match using algorithms and data previously stored by onboarding, scraping, and other data gathering methods.

The system may also allow a node to search for, join, and/or host video and/or audio conversations on any topic. In order to do so, the system may for example comprise a conversation module configured for searching, joining and/or hosting such video and/or audio conversations. The conversation module may comprise a list configured to keep track of topics and conversations. The list may simply be stored in a memory of the system.

The list can be updated by individual nodes, enterprise nodes, the system administrators, and/or others. It may also be updated manually and/or automatically, by way of social and other topical updates and other sources (e.g. the system is connected to a news feed, and as it detects a significant current affairs matter (e.g. a news item trending significantly on a media platform), and automatically adds that to the list of, for example, actual and/or recommended speaking topics.

The system may, for example, have topics and conversations categorized by topic, organization, speaker, popularity, country, language, profession, industry, and/or others.

The system allows a node to host, and/or simply join the conversation, a live audio and/or video session to talk and/or present on an area of interest, expertise, or other area a node wishes to speak about, by using audio and/or video online streaming, recording and playing systems.

The system may continue to gather data in order to continue to refine its algorithmic and other analysis, for example, by using natural language processing of what is being said, typed, displayed, commented on, or any other way, to for example inter alia identify the topics of the conversations or any other element. The system may then use this data, for example, when suggesting certain audio and/or video live events or recordings to nodes who the system determines are most likely interested.

The system allows a user to join such events live, or to listen to a recording of such events at a later date. The system allows a broadcasting user to invite other nodes, or potential users (in line with any access rules set by the node, an enterprise node of the system, or the system, or any other rules, as described above), to participate in, or host, alone or jointly, the audio and/or video conversation. As for access rules, for example, an enterprise node of the system may select to make an audio event available only to its employees and not to any other nodes of the system (e.g. employees of a different enterprise node or private consumer nodes). Or, for example, the system may allow an enterprise to select to make an audio event accessible only to recent new employees of that enterprise, or for example, the system may allow an enterprise to select to make an audio event accessible only to nodes of enterprises falling within certain categories or industries.

In addition, the system may allow, before, during and/or after a live event or the watching of a recorded event, users who are not already connected, to message, follow, and/or add each other as a connection on the system, or to schedule a meeting with each other, or any other action. The system may also take the above into account when creating new matches.

The system may also include a wall, which, in addition to allowing a node to post, and other nodes to view, messages, photos, reactions, comments, and other elements, to record and post audio and/or video streams to the wall.

These audio and/or video streams are then listenable to other nodes (in line with any access rules set by the node, an enterprise node of the system, or the system, or any other rules, as described above).

### New Podcast

The system may also bundle numerous audio and/or video clips, including clips from different nodes (for example, on similar topics) and allow play of these one after another with a single tap or click in a manner that resembles a traditional podcast or playlist. Thus, the system may collect, label, batch, and/or categorize or otherwise handle different clips, recordings, and the like, by the same presenter and/or by other presenters, and allow play of these by way of a single play button, or other automated way. Thus, for example, the system may allow interaction by an API or user interface to click on a play button and then continuously listen to numerous audio clips on a certain topic, or several topics, whether by one speaker or several speakers, whether within a specific industry or otherwise, and the like, consecutively just as in the fashion of one listening to a music playlist. Alternatively or additionally, the clips may be bundled (also) by another criterion than having the same presenter, for example by detecting overlapping subject-matter based on textual analysis, by detecting similar auditory and/or visual style (e.g. overall length, scene length, frame movement speed, pitch evolution, etc.).

Users may also have the option of commenting on these clips and/or podcasts, and to like, share them, and the like. Such comments may be kept as metadata, and may be useful to other nodes for searching. The sound of audio-clips and video clips may also be automatically trans-scribed, thus allowing textual search.

### Looking-for Wall/Database, Work Staffing Wall/Database

A system that allows nodes to, amongst others, post or otherwise publish or display or notify other users of their availability and/or capacity to assist others. For example, the system may allow an employee of an enterprise node to, for example, and amongst others, post to a wall or to another form of portal feed that is accessible to other employees of that enterprise (or, for example, to a relevant other enterprise, or enterprises, or other nodes), that they have capacity to take on work.

In addition, the system may allow users to, amongst others, post or otherwise publish or display or notify other nodes of their request or need for assistance and/or support. For example, the system may allow an employee of an enterprise node to, for example, and amongst others, post to a wall or feed, or say, for example, add to a database or webpage, that they are looking for an immigration lawyer with a certain specific expertise or experience (e.g. diversity visa expertise).

The posts may be visible to other nodes, and the system may show the posts to the most suitable audience, using algorithmic analysis and other processes, in addition to applying the rules set by the node or by the enterprise node (e.g. the enterprise node may select to make such posts visible only to employees of said enterprise, as described above). For example, and as described above, the system enables different enterprises and nodes to set specific visibility rules; thus, for example, enterprise node A may set all capacity/availability posts by its employees to be visible only to its employees.

In addition, the system may include various search filters, such as by employee name, departments, experience, expertise, office location, practice group, and similar. It may also allow nodes to describe the type of work they are looking for, have experience in, or time and timing of node's availability of or for projects. The system may also allow for the gathering and demonstration of metrics, regarding for example work, efficiency, target hours, number of users using or visiting the system, and similar, and the showing of the company's top clients, matters, leading nodes, and nodes in charge of matters, and their contact details, titles, and other relevant data. It can also facilitate, as described herein, for example, connectedness, interaction, coherence, and data flow.

The system may also, using algorithmic analysis and other processes, match or otherwise introduce nodes to each other based on such posts described above or in any other manner. The systems described may be used in combination, in whole or in part, with any of the systems described elsewhere herein, or on its own, or in any other manner or combination.

### Anonymous Phone Call System

A system may enable two or more nodes to be connected in an automated and scalable manner by the traditional telephone without either user knowing or otherwise being provided with the other node's or nodes' phone number(s). In addition, the system may automate the triggering of such calls so that one or more nodes need not dial a number—rather, the system automatically calls such node or nodes, and when two or more users pick up their respective ringing phone such nodes are connected with each other.

The system contains a database which is populated with matches of nodes or groups of nodes or other information on nodes. For example, the database specifies that Node 1 and Node 2 are to be connected. For example, Node 1 and Node 2 may have been matched through algorithmic analysis or other methods, for example, but not limited to, by any of the systems described above. The database to which the system is connected to, and has access to, contains the phone numbers of, for example, Node 1 and Node 2.

When a node dials a certain phone number owned, controlled or otherwise managed by or related to the system, the system answers the call and identifies the incoming caller ID and then looks up the caller ID in the database to which the system has access to. The system may then obtain from its databases the phone number of the corresponding match of that node (e.g. Node 2). The system may subsequently dials the number of that node, and once that node answers the call, the system connects the first node with the second node. That way, a call may be created between two nodes (or more nodes) whereby neither is provided with information on or access to the phone number of the other node or nodes. (See for example FIG. 7.)

In FIG. 7, the calling system flow chart is shown as an example. In FIG. 7, the node database 700 is in communication with the system and thereby, the match database 702 and the phone system 710. The system checks 708 the caller identification and runs a match through the node database 700 and match database 702. The system may identify a second party to match and look up a phone number from the database 714. The system may trigger an outgoing call to another party 716. The system may bridge a call for a connection 712. The system may send an SMS or other reminders for prompts 706. The system may use logic and process for handling missed calls, answering machines, time zones and scheduling 718.

Regarding FIG. 7, Calling System, User Database 700, Match Database 702, incoming call 704, Send SMS and/or other reminders or prompts 706, checks caller ID and runs match through user database and match database 708, Phone System 710, Bridges call one with the other call 712, Identifies second party to match and looks up phone number from database 714, Triggers outgoing call to other party to match 716, Logic and process for handling missed calls, answering machine, time zones, scheduling, and the like 718.

In addition, the system may provide one or more links, by way of for example email, SMS, notification, or any other method, which, when clicked, triggers a phone call by traditional telephone or by online audio (e.g. VOIP) or video.

The system may also include reminders or other messages sent by the system to a node, for example by SMS, email, audio call, or other manner. Such message, for example, may, for example, be a reminder to a user to dial the phone number owned, or controlled or otherwise managed by the system, and, for example, reminding the user that it is now the time slot during which said node was matched and scheduled to connect with another node.

In addition, the system may monitor the duration of the call and/or other elements. If, for example, the system identifies that a call's duration is shorter than a predefined threshold (e.g. 5 seconds), it may deduce therefrom that the call went to an answering machine and hence send a reminder (or other message) to either node or take any other action on the basis thereof.

In addition, the system may be so set up to be fully automated: i.e. no need for any user to dial the phone number owned, controlled or otherwise managed by the system. The system, through its data gathering methods described above, may obtain data, including the time of when a call is scheduled to occur, or when the system otherwise using its algorithmic and/or other analysis determines that it is a good time to trigger the call, and the details of nodes to be connected, and the phone numbers of those nodes, and stores these in a database(s). At the designated time, as set out in the data obtained by the system or so decided by the system, the system dials each node. When two or more users answer the phone, the system connects each node to the other. If there is any time lag between one user answering the phone, the system may place that node on hold, and, for example, play an automated message or a tune, until a second user, or other users, answer their phone, after which the system connects them to each other. In addition, this system and method can be used also for video communications.

In addition, the system may use algorithmic analysis and/or other processes, including artificial intelligence and/or machine learning, including natural language processing of call transcripts and/or recordings, and/or through voice or other analysis, including but not limited to the nodes' synchrony (e.g. using voice pitch) to provide better services. Such information may be fed into the learning algorithms for the machine learning/artificial intelligence models. For example, such analysis, processes and/or data may be used to improve the quality of future matches and/or connections of such nodes.

The systems described may be used in combination, in whole or in part, with any of the systems described elsewhere herein, or on its own, or in any other manner or combination. All systems and methods described herein may be implemented in whole or in part via cloud computing, in addition to other forms of implementation.

In addition to the above, the user experience includes and is not limited to a registration and onboarding experience, a dashboard, a meetings calendar, rescheduling, emailing system, and/or other elements, all of which may be available by browser, web application, mobile app, hard copy paper, phone dial-in, and other ways.

### CONCLUSION

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The innovations herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the present inventions may be implemented via computer-hardware, software and/or firmware. For example, the network systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words comprise, comprising, and the like are to be construed in an inclusive sense as opposed to an exclusive or exhaustive sense; that is to say, in a sense of including, but not limited to. Words using the singular or plural number also include the plural or singular number respectively. Additionally, the words herein, hereunder, above, below, and words of similar import refer to this application as a whole and not to any particular portions of this application. When the word or is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

What is claimed is:

1. A method comprising:
by a computer with a processor and memory, receiving data regarding a first node;
matching the first node data with a second node data based on the received first node data by comparison to previously stored other nodes in a database;
scheduling a communication between the first node and a matched second node from the database using data of the first node and stored data of the second node;
initiating the scheduled communication between the first node and the second node using the first node communications data and stored communications data of the second node;
receiving data regarding the communication between the first node and the second node.

2. A method comprising:
by a computer with a processor and memory, receiving data regarding a first node including geographical data and communications data;
matching the first node data with a second node data based on the received first node data by comparison to previously stored other nodes in a database;
scheduling a communication between the first node and a matched second node from the database using the geographic data of the first node and stored geographic data of the second node;
initiating the scheduled communication between the first node and the second node using the first node communications data and stored communications data of the second node;
receiving voice data regarding the communication between the first node and the second use, wherein the voice data includes tone data;
comparing the received voice data of the first node and the second node to a predefined threshold of tone above 150 Hz;
if the received voice data of the first node and the second node exceeds the predefined threshold of tone, storing an indicator of success.

3. The method of claim 2 wherein the voice data is a speech recording of a telephone conference.

4. The method of claim 2 wherein the comparing step uses a natural language processing engine to determine the match.

5. The method of claim 4 wherein the matching utilizes a check of whether the first node has opted for a wildcard match, and if so, overriding algorithms used for matching and utilizing a random number generator to match the second node.

6. The method of claim 2 wherein the matching of the first node and the second node includes matching both a stored Boolean value and a scaled value.

7. The method of claim 2 wherein the matching includes a specific purpose variable and weighted factors for matching based on the specific purpose variable.

8. The method of claim 7 wherein the matching includes an index file match or previously stored data flags for each of the node.

9. The method of claim 2 wherein the scheduling includes utilizing geographic data of the first node and geographic data of the second node along with previously stored calendar data of the first node and calendar data of the second node.

10. The method of claim 8 wherein the matching is made by a daemon module configured to monitor for matching criteria in the index file to match the first node data.

11. The method of claim 8 wherein the matching includes only time stamped data that has not been expunged from the database for aging over a predefined time limit.

12. A computer implemented method comprising:
by a computer server, receiving data from a first node by a registration webpage API, and updating the digital database;
by the computer server, receiving data from the first node by an onboarding questionnaire and updating the digital database;
by the computer server, receiving data regarding geography of the first node, and updating the digital database;
by the computer server, receiving data regarding online web browsing activity of the first node, and updating the digital database;
by the computer server, recording audio data of a voice of the first node to create audio data of the first node, and updating the digital database;
by the computer server, applying natural language processing to input from the first node, and updating the digital database;
by the computer server, storing all of the data regarding the first node in a data storage, and updating the digital database;
by the computer server, receiving data from a second node by a registration webpage API, and updating the digital database;
by the computer server, receiving data from the second node by an onboarding questionnaire, and updating the digital database;
by the computer server, receiving data regarding geography of the second node, and updating the digital database;
by the computer server, receiving data regarding online web browsing activity of the second node, and updating the digital database;
by the computer server, recording audio data of a voice of the second node to create audio data of the second node;
by the computer server, applying natural language processing to input from the second node, and updating the digital database;
by the computer server, storing all of the data regarding the second node in a data storage, and updating the digital database;
using the data regarding the first node and the data regarding the second node to determine a match; and
if a match is determined, sending a communication to the first node and the second node to initiate communication between the first node and the second node.
